(19) United States
(12) Patent Application Publication
(10) Pub. No.: US 2016/0352158 A1
(43) Pub. Date: Dec. 1, 2016

(54) Generator

(71) Applicant: Robert Derle McGee, Angier, NC (US)

(72) Inventor: Robert Derle McGee, Angier, NC (US)

(21) Appl. No.: 14/999,680

(22) Filed: Jun. 13, 2016

Related U.S. Application Data
(60) Provisional application No. 62/386,697, filed on Dec. 10, 2015.

(51) Int. Cl. H02K 1/06; H02K 3/04

(52) U.S. Cl. CPC H02K 1/06; H02K 3/04; H02K 53/00

(57) ABSTRACT

Enclosed is the Abstract of the invention. The abstract of the invention is that it is a hovering generator. Polarity hover in conjunction with faculties create a Generator of power. A generator that uses polarity push from its parts to float. It is a hovering grouping of parts. Its abstract is a hovering Generator.

### GENERATOR, BACKGROUND AND HISTORY

I started early in life on it and developed it over time.

The details, are mostly delete now and are lengthy and the reader may wish to skip to the next section,

### SUMMARY

This Generator is for more unlimited power.

Based on magnets as natures own perpetual motion devise the Generator is noticeable as the biosphere rotting as a continuous. The field of endeavor is energy. The subject machine uses hovering and push out by polarity and coil on coil to produce alternating current. The machines more complex parts have their own coil on coil current bled and going back into the machine part for polarity float, perhaps AC to DC converted. Polarity pushes out other such parts, hovering. Coil on coil product current.

Production of surplus power. Proper quick description is magnets or electromagnets or mix, their parts own coil bled for the current they would need, sames repel polarity push out, inner edges pushed away from previous outer edge, continuing, with under and over or through polarity hovering more “above and coil on coil energy production. This is a machine that can go concentric out. The art was hindered by not using a natural continuous devise as easily now noticeable as natures own magnets. The subject will help in energy needs.

The film was made with Pat Penny of P&D Sales VCR camera and the tube version was mostly described there. P&D Sales can provide you with a Rainbow at (919)894-5551 or help you with repair of one. They helped a lot in letting me use it to make the movie. It may be something you can handle internally that the first 90's film of the VCR tape of the apparatus is more than sufficient, there.

The History Description is long but reasonably accurate and I would have docked some information, and did, but for trying for pertain at detailing while realizing such as most life history not here, now. As from my your I was against spies, I worked toward an absolute platform that included handling the fuel crisis. I developed the engineering, carpentry/architect skills and work steady with minimalist tools(especially if I ever got to go up.) . . . I developed the ability to . . . retain . . . though without turning the walk-ums tassel retain across times by staying singularity of purpose on the machine I was developing for the then fuel crisis and potential others.

I wasn't tardy, The Generator was difficult and, as well as any start, the only start at all interesting started as a flywheel that cut in and out from electricity by at the first what I thought solar or step flywheels might work and is interesting only at as water heated from, around the flywheel, circular array of solar curves with a target tube of oil, heated, like in an old Popular Mechanics Magazine, which was my favorite feed your head—food—absorbing into basic I Am and dropping all but the non-max headroom of what I are, like a sponge going to be wrung. I had been lucky, which is the only real word for it, saying logged it in now, The Lucky Years. There was no Eureka or anything, just this has to be done on time and that almost worked a bit so if not then go to or then gone. I had it by UNC-CH but there I started toward real Poly Science and, taking a break for IOBC, a bouncing stop rapid fire cooled my WACO 1985 for a twenty year hunk to be taken out of my life. Got rid of the “I don't care, I want the big one . . . ’ wild things, though. Not real important in this, but helps to understand that the machine as well as my life has been frozen for twenty years with no change and its like I just woke-up. I recommend cryro, aimed by our numbers for the future to be successful that to the future, liquid nitrogen cracks to the brain are nothing and, with our goldfish(near alone) and not just the head(sorry, your back too!) we can stop waste of creation by ice, ribbon, now. Woooww . . . Forget you, were on this Now! This commercial is over. So is the P&D Sales one. This is kind of interesting; I read in a school text that two tops with a string between them move along it by gyroscopic precession if you bend the axle’ between them. This machine is a field day for that gyroscopic precession. Bled current for as if for itself in regular magnets or for itself in using electromagnets, disc parts hover and push others out with the part's own individual coil giving the part it's electricity and outside coils for surplus product, both coil on coil, resultant power. Magnets by their innate properties cause product at avoidance of problems associated with previous attempts. Polarity floating and pushing more like themselves out, parts bled their own coil power for polarity and surplus by coil on outside coil. Start at least using some bar magnets. A lot of the following are in the Detailed Description. Easy enough to understand for this, deflect bar magnets to push, . . . or use a oscillating T, a rotating T, or use a . . . !—The Mix. Last about that is uninhibited in most things by then to at least a whatever to any thing you aimed at spied a brick. So the kid was eating and being fed though please be more careful in feeding your head though I know the lucky years don't want minutes on a landline to not be other than at least the type of earthling that doesn't notice the old’ are you an earthling solve the code. So as not controlled, here I must admit that I am computer illiterate and hate even keeping a dead phone to be an earthling. The last of the wasp gone with WWII worst mistake the Wall Street Journal and us 3(4) latched in in this off the peripheral by the real How I Gave Up Hating and Learned . . . Rupen (Yeah, like so thick a war couldn't see it yittler) professor of the spy to a sickum of CIA and KGB just because we both read my Readak notes. If you know so much as that the Interpol Scotland Yard net is just the same spies, go tell them all. That does make sense at least to them. To you, Cheer's(and I mean it), you've solved the puzzle of the British are coming down to not just fire works but that they are actually bad for all the presentation of Diplomacy, as in the cartoon showing it in the Revolutionary war segments flicks. Carry the B. And in cryro, if the door opens, it closes again, no problem. Oh, and those people are crazy-stay away My little Rubic's cube has just poped up on me again.

### SUMMARY

Proper quick description; Magnets or electromagnets, their parts own coil bled for the current they would need, sames repel polarity push up and out. Inner edges pushed away from previous next outer edge, continuing, with under and over or through polarity hovering more ‘above and coil on coil energy production. Polarity push and hover up and out with non-conductive medium and mix or bar magnets or electromagnets, such as can be made from a bolt and nut with covered wrap copper wire, to indicate sturdy, the circle out's own coils bled for such as polarity and exterior coils by coil on coil producing energy. Possible long term synthesis development of coal.

### BRIEF DESCRIPTION OF DRAWINGS

### Generator, Section 4

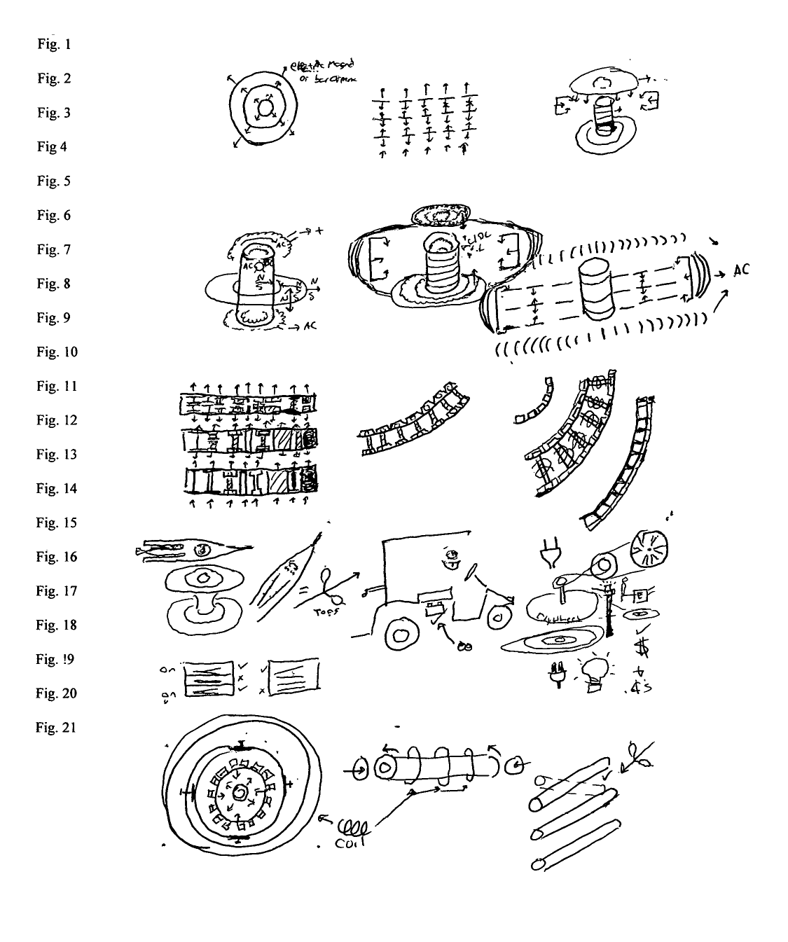

FIG. 1 Concentric out

FIG. 2 Polarity push out

FIG. 3 Hovering

FIG. 4 Axle pushes.

FIG. 5 Base, top, and bull prevent explosions

FIG. 6 Coil on coil produces alternating current (AC)

FIG. 7 AC/DC converters, balanced or such as balanced best, provide such as electromagnets power

FIG. 8 Stationary axle's coil as dish moves around it with it's coil, has effect of its own energy polarity

FIG. 9 Top, bottom and hull And axle, steady, have polarity by their coils being bled, although stationary

FIG. 10 Product energy coils are arranged not to impede apparatus’ proper

FIG. 11 Hollow, solid thick, or thin disk can be used. The last especially enlarged, float still seen

FIG. 12 Different steel rods can be used, wrapped, or you can even use bar or refrigerator magnets

FIG. 13 Here, the deft medium is shown important, even if it is glue

FIG. 14 Bored at or near for flush, holes' enable Nearly Squares with Them having bolt and nut Indent

FIG. 15 Machined Plateau: cardboard/frig mags-flexi glass/covered wrap bolts-ceramic and advance E-mags

FIG. 16 Dream move by of counter rotating concentric hulls and interior flywheels for gyroscopic precession

FIG. 17 In freefall one on to is attainable stop and slowing to rev again as the next gets up its part of speed . . . .

FIG. 18 More sales for electricity in better transitions' for electric motors, perhaps flywheel based, makes $

FIG. 19 A housing bouncing betty into a plug, small version on a 30 watt's stem, hook to a rev up flywheel . . . .

FIG. 20 Portable generators not on fuel, massive arrays, light for going up to have great wind fall of power . . . .

FIG. 21 Cylinder Version

### GENERATOR, DETAILED DESCRIPTION

Magnets are nature's own perpetual motion devise.

Load stones are found on earth in nature.

Load stones rubbing a steel rod produces some magnetic polarity on the steel.

Polarity is north and south.

Every magnet has a north and south.

South on south repels.

North on north repels.

South on north attracts.

North on south attracts.

Same repel, opposites attract.

Coil on coil produces alternating current.

There are alternating current to direct current converters. These are plentiful.

Over times, as with the future there are better AC to DC converters develop.

A better converter can have a steady effect other than but as in a circle’ by also such as counter balanced.

Counterweight or other balance can be used. A drag slide rule for spin speed weighted even.

Wrapping, like, tightly around a steel rod with copper wire, back up, and then more wrapping in the same direction produces an electromagnet when you throw power to the copper ends.

You might use covered wire.

Electromagnets have a north and south and work similar to bar magnets.

Any DC battery can provide some DC current; also applicable as a replaceable potential part to the apparatus being described in this book section and step up and step down transformers in a near circular array can produce some power. The parts can be high voltage. But this slip-streamed own-motion hull is a bit alien and little stoic and not art deco for earth. Even if you use and replace heavy weight parts. Don't forget to dig the hole and build the dome.

There is no real need to think of the device's balance should be affected by the planetary poles.

Working toward give, prevents in latter industrial models the need for exacting low tolerance.

A DC battery can provide some electricity for a wrapped rod to be an electromagnet,

An electromagnet can be made.

An electromagnet has its own magnetism.

An electromagnet has it's own north and south, and it's own same attraction and opposites polarity push.

Catalysts; like, plastic glass, ceramics, and other readily available non-conductive materials can be used as a deaf medium. An amount of conductivity that may vary in different apparatus may help.

Flush is a word describing to near exact placement, smooth on/or top and bottom.

Start using regular magnets. Latter you can use electromagnets in much the same way.
Many would or May or Says

Avoid sudden dispelling of the apparatus. Perhaps also show a way of the forces involved simply.

Think toward a mindset of restart but without causing it such to be needed. (The Army will be good at this; not relying only on such as hidden but also contingencies that are never their own cause even ready People in here where Alex can do so much good, though not overboard in money@like wooden nickels.) Use the innate re jerk nature of magnetism. As the field lessens in its force to ‘give and the next is jumped over to a strong pull. Occasional finds of re grab may be what you are looking for, like in recent industry.

I'll use one by someone else. A thing is easy once done.

A form of flipping the magnetic field. Magic and magnetic are similar words, eh?!,Power off next on Use a timed, electric eye timed[(which can also be developed into improvements, like in spin), it's power bled and converted], and/or automatic mechanical drop or that same but also off a slide rule instead of hitting a release even/or/and in magnetic field and which itself could also be other than easy as a distance between, next magnetism pull.

As a field nears it's fade, a strong arranged field pulls.

Fold the old field quickly at a ninety degree angle as an end to that bits pull, by mechanical or other (slide rule enacted . . . ) and the next strong field fields.

More horse power by increasing pull strength, That even if speed becomes most of the uses. For such that are less prototypes these powerful pulls could hook up to larger coils, or meander as a hair to thread to eventually rope. Backtracking this is moving toward more horsepower.

Use deep focus. Set further back . . . from flush and angled with even occasional . . . reverse polarity—turn around these magnets—giving a jump.

Wait for other's improvements.

Polarity arranged just inside and angled and turned or other trial and error experiments, here harmless, but, please with a guaranteed good resultant from scientific method. Straight to, Wiz.

Remind each other not to use but compassionate competition and avoid dispel.

Derive electric motor hints.

A tuning t magnet or it oscillates back and forth.

Flip the magnetic field sections.

Prepare for a simple presentation to the public avoiding dispel or ozone blimps.

paper process to first time max-out perfect can be done, but you don't have to worry about wasting paper . . . . Amount of production can be extreme by being over engineered to even capturing the greatest amount of current even to the size difference in the dishes outer and inner coils.

That each dishes own coil as it moves in relation to the next interior coil out is much like one likewise on the interior axle with the first coil—first out—spinning while the axle(tubular shape) stationary but the coil on coil even with one not moving causing AC power, say for the axle's bled and converted polarity push or electric eye (perhaps prepared special such as for catch in increasing power at correct intervals, and spacing or even to ‘think in adjustments)—and/or—(prepared for’ in-flight adjustments in polarity push out, while stationary, but working to float out the first dishes inner edge flush magnets with it's own outer edge flush magnets much like the first floating doughnut pushing by polarity the next dish out. On the achieved by stationary or moving (as, though easier not to talk about that the axle can be made to move except here . . . ) base—not the axle ‘proper in the unmoving center cylinder of up in lines of push themselves incrementing to the top if more than one doughnut is used(noteworthy here is that a capping, stationary or moving polarity push down top may also aid in preventing the apparatus from explosive. The top, at baseline, receives its polarity push and electric eye energy in much the same way the axle does.) And the other concentric dish's floating flush magnets out and those aimed up for next dish up float(This is better, but yes you don't have to use each others section or whole polarity push.), perhaps with a beginning presentation of the machine that includes crutches beyond more than counter weights. And, of course, adding dishes out and up and out. (And, perhaps an outer perimeter ‘close-ring steadying and with it's power derived in much the same way as the axle. And up by under polarity push magnets on an under dish or a non-moving or moving polarity push up base, its coils perhaps stationary as the axle can be such as stationary and coil on coil is the only effect needed to derive energy. While the base and top and outside steady and axle can be made to move this is a simple way of understanding it. At each—or one—notch of polarity up for stacking dishes—or one—on the axle there is the at or near flush push away polarity for the first one level or (maybe changing distance) stacked plumb dishes, bleeding more power and weaker˜ for level distance. Perhaps incremented climbing(though useful, this is not to be confused with the difficult but productive development/maneuver of screw pattern or such around the axle for rising plate distance modifications.) from the first inside rising line around the axle, steady or variance lines, pushing for a stack of doughnut dishes and their floating magnets lip (maybe at or near flush) out to the next ones or stacks of doughnuts out beyond this second one maybe many more dishes out, (perhaps one day even cluttered synthesis out by the previous ring going to a point of building the next and then more to a point of flap producing further to perhaps a rip fan such as to deft dimensional power facilities and even as stationary infinite more disks produced just outside tinsel strength. Such would be a good test bay and use of a theoretical karate chop reflection or even refraction of perfect Hubble mirror surface tension for single layer, of cool to itself bounce back of all heat or other with strength unnecessary. This, more than a parasol, is a good market for its hard development.) If desired, there is a second and other stacks of dishes out as the second and more as well as hovering from their bottom one by polarity. (Restrained synthesis of unending, though initially crude, coal could help pie %.) Many after placing one dish for an apparatus may be missing out on stacking dishes to a steadying top.

Concentric floating by polarity doughnut dishes with each coil on coil powering by bled its such as electric eye or electromagnets and surplus power even by under and/or above coils to be bled surplus.

I know, but WWII Germany developed coal to petrol. Helps me, coal, gas.

Using coils in ways not in the way of the devise and floating, it is important to understand coil on coil concentric out is non-inhibiting the machine proper easy. Easy understood is in practice, again for ease, that the mechanisms workings are not hampered by coil on coil, though their product the energy. And that the coil on coil bend to the machines float, electric eyes, and AC/DC converters still places it in great areas and with great resultant. Torque not beyond polarity and spin mechanics and them, ‘coils, offset at places around and not impeding the devise it self's capabilities such as float capabilities allows coils shaped and juxtaposition almost anywhere. Maybe avoiding cattycornered. And working the same as, they, coil on coil, arranged concave around the dishes and in relation to themselves can at this one place be described much as fancier placement but still, coil on coil describes in other places well enough. Without time and effort management consultant perspiration as this section could produce, regular way of saying it is fine. Like saying too much is only an ignorable, repetition clarity can also prevent dispel. Amounts of coil thickness can be reduced or increased by such as a snaking of layers,’ wing warping or spreading including slinky, or even varying sizes for the machine's production to even be kept at or near optimum. This as a’ best description, but not all of potential. And the machine proper has bled power to itself and has its own coils for parts to have an ample amount of power. This important as you move in transferring priorities in best blend of machine proper in variances and its coils and the production’ coils.

Easiest to understand in an envisioned prototype is that the coils are placed later at optimum and are in first practice anywhere else but what will at all impede the devises own float, AC/DC converter and electric eyes . . . . Coil on coil is, except for here as a known, the best description. Keeping for growth is a part of this patent. Pushing beyond it not encouraged. If these two sentences do not help in this, consider them and this one struck. Feel free to use white out. And likewise on the next one or two. Even with all too quick resultant developed by this is too big and I thought of it and it must be mine puzzle workout people—you give me credit though it to you be only realizing magnets are natures own perpetual motion device, and pushing even in this for mine to be potentials under at least regular developmental expansion. Magnets full potential being realized.

Such known, regular or electromagnets hovering by polarity some dishes which themselves hold further doughnuts out by polarity and the parts such as dishes bleeding the energy they, the individual dishes' need for their function such as hovering with the whole using offset coil on coil for electricity production is still among the best present descriptions. Magnets in and around both interior and exterior curves of solid or hollow flexi-glass doughnuts float the next doughnuts out and all the doughnuts can have polarity push up by a circle of magnets floating up more doughnuts that can also push more out and the bled from their own coils power each doughnut needs can come from its own coils by coil on coil producing AC which by AC/DC converter, at least counterweighted, can also feed the doughnut and coil on coils to the exterior of the working machine produce a byproduct of electricity in one of the most efficient attempts ever to get full benefit of work effort by such as fire or heat directly into work effort.

Sames repel polarity push out, inner edge pushed away from previous outer edge, continuing, with under and over or through polarity hovering more above’ and coil on coil production. Magnets or Electromagnets, or mixed. You don't even need the drawing.

Separate if by white-out . . . Not without Priest, Wiz(nano), but a covered wrapped in the same direction no-miss scientific method could provide the believable norm for the creatures inside a lot of’ magnets, natures own perpetual motion device. ˜Funny how think about wrapped wire around steel seems to have only come after the invention of the battery, even with citrus everywhere back to the cave men. Final aiming is enjoyment, The Roaring 20's new what they had and, art deco, all you got to do is swing. Magnets or electromagnets or mix, their parts own coil bled for the current they would need, sames repel polarity push out, inner edges pushed away from previous outer edge, continuing with under and over or through polarity hovering more ‘above and coil on coil energy production˜ The brief summary I am using.

When a Corp. builds its first . . . model . . . of the machine, Plastic-Glass—Flexi-Glass is recommended for the non-conductive frame.

Glue works on raising off the sheet below to the right height you need for

any base start and on next phases. Diagonal brace Flexi can all but handle a long screw or perforated for toward a final assembly cut and glue along non-right angles. At this point you could even use that glue in a mold. For an example, on the edge circular curve, light Flexi-Glass can be thick sliver cut and bent around say, two outside wheels(doughnuts) and glued to be the tread around the tire’; glued the strip's edges met and melted or glued together. Nuts and bolts with even not so smaller washers can help rigid and, with wound covered wire make great electromagnets using this extra area Even if with refrigerator magnets and cardboard, it is recommended to start out using regular magnets.

It Strained.

I started early in life on it and developed it over time.

The details, are mostly delete now and are lengthy and the reader may wish to skip to the next section,

### SUMMARY

This Generator is for more unlimited power.

Based on magnets as natures own perpetual motion devise the Generator is noticeable as the biosphere rotting as a continuous. The field of endeavor is energy. The subject machine uses hovering and push out by polarity and coil on coil to produce alternating current. The machines more complex parts have their own coil on coil current bled and going back into the machine part for polarity float, . . . maybe some AC to DC converted. Polarity pushes out other such parts, hovering. Coil on coil product current. Production of surplus power. Proper quick description is magnets or electromagnets or mix, their parts own coil bled for the current they would need, sames repel polarity push out, inner edges pushed away from previous outer edge, continuing, with under and over or through polarity hovering more “above and coil on coil energy production. This is a machine that can go concentric out. The art was hindered by not using a natural continuous devise as easily now noticeable as natures own magnets. The subject will help in energy needs. In biosphere we're small and can receive unlimited dose of area of opportunity, elec.+

The film was made with Pat Penny of P&D Sales VCR camera and the tube version was mostly described there. P&D Sales can provide you with a Rainbow at (919)894-5551 or help you with repair of one. They helped a lot in letting me use it to make the movie. It may be something you can handle internally that the first 90's film of the VCR tape of the apparatus is more than sufficient, there.

The History Description is long but reasonably accurate and I would have docked some information, and did, but for trying for pertain at detailing while realizing such as most life history not here, now.

As from my yout I was against spies, I worked toward an absolute platform that included handling the fuel crisis. I developed the engineering, carpentry/architect skills and work steady with minimalist tools(especially if I ever got to go up.) . . . I developed the ability to . . . retain . . . though without turning the walk-ums tassel retain across times by staying singularity of purpose on the machine I was developing for the then fuel crisis and potential others.

I wasn't tardy, The Generator was difficult and, as well as any start, the only start at all interesting started as a flywheel that cut in and out from electricity by at the first what I thought solar or step flywheels might work and is interesting only at as water heated from, around the flywheel, circular array of solar curves with a target tube of oil, heated, like in an old Popular Mechanics Magazine, which was my favorite feed your head—food—absorbing into basic I Am and dropping all but the non-max headroom of what I are, like a sponge going to be wrung. I had been lucky, which is the only real word for it, saying logged it in now, The Lucky Years. There was no Eureka or anything, just this has to be done on time and that almost worked a bit so if not then go to or then gone. I had it by UNC-CH but there I started toward real Poly Science and, taking a break for IOBC, a bouncing stop rapid fire cooled my WACO 1985 for a twenty year hunk to be taken out of my life. Got rid of the “I don't care, I want the big one . . . ’ wild things, though. Not real important in this, but helps to understand that the machine as well as my life has been frozen for twenty years with no change and its like I just woke-up. I recommend cryro, aimed by our numbers for the future to be successful that to the future, liquid nitrogen cracks to the brain are nothing and, with our goldfish(near alone) and not just the head(sorry, your back too!) we can stop waste of creation by ice, ribbon, now. Woooww . . . Forget you, were on this Now! This commercial is over. So is the P&D Sales one. This is kind of interesting; I read in a school text that two tops with a string between them move along it by gyroscopic precession if you bend the axle’ between them. This machine is a field day for such gyroscopic precession. Bled current for as if for itself in regular magnets or for itself in using electromagnets, disc parts hover and push others out with the part's own individual coil giving the part it's electricity and outside coils for surplus product, both coil on coil, resultant power. Magnets by their innate properties cause product at avoidance of problems associated with previous attempts. Polarity floating and pushing more like themselves out, parts bled their own coil power for polarity and surplus by coil on outside coil. Start at least using some bar magnets. A lot of the following are in the Detailed Description: Easy enough to understand for this, deflect bar magnets to push, . . . or use a oscillating T, a rotating T, or use a . . . !—The Mix; last about that is uninhibited in most things by then to at least a whatever to any thing you aimed at spied a brick. So the kid was eating and being fed though please be more careful in feeding your head though I know the lucky years don't want minutes on a landline to not be other than at least the type of earthling that doesn't notice the old’ are you an earthling solve the code. So as not controlled, here I must admit that I am computer illiterate and hate even keeping a dead phone to be an earthling. The last of the wasp gone with WWII worst mistake the Wall Street Journal and us 3(4) latched in this off the peripheral by the real How I Gave Up Hating and Learned . . . Rupen (Yeah, like so thick a war couldn't see it yittler) professor of the spy to a sickum of CIA and KGB just because we both read my Readak notes. If you know so much as that the Interpol Scotland Yard net is just the same spies, go tell them all. That does make sense at least to them. To you, Cheer's(and I mean it), you've solved the puzzle of the British are coming down to not just fire works but that they are actually bad for all the presentation of Diplomacy, as in the cartoon showing it in the Revolutionary war segments flicks. Carry the B. And in cryro, if the door opens, it closes again, no problem. Oh, and those people are crazy-stay away My little Rubic's cube has just poped up on me again.

Ship this and all Raider's boxes, best, to the NCANG, secret in Reserves.

It strained.

Proper quick description; Magnets or electromagnets, their parts own coil bled for the current they would need, sames repel polarity push up and out. Inner edges pushed away from previous next outer edge, continuing, with under and over or through polarity hovering more ‘above and coil on coil energy production. Polarity push and hover up and out with non-conductive medium and mix or bar magnets or electromagnets, such as can be made from a bolt and nut with covered wrap copper wire, to indicate sturdy, the circle out's own coils bled for such as polarity and exterior coils by coil on coil producing Energy (with it's own.), —automatic mechanical drop or that same but also off a slide rule instead of hitting a release even in magnetic field or such, which itself could also be other than easy as a balanced bump placed to not cause a detrimental spin falloff. Meet the family cave man rock station. Concentric. As a field nears its fade, a strong arranged field pulls. Strung diagonal from the previous E-Mag to make winds of the next, continuing, ends to bled power for that array.

Fold the old field quickly at a ninety degree angle as an end to that bits pull, by mechanical or other (slide rule enacted . . . ) and the next strong arranged field fields.

Use deep focus. Set further back . . . from flush and angled with even occasional . . . reverse polarity . . .

Turn around magnets . . . toward giving a jump.

Many may wait for other's improvements.

Remind each other not to use but compassionate competition and avoid any dispel.

Derive electric motor hints. Perhaps as near a field end, steady or jerky drop its and jerky or steady increase the next's power.

More horse power by increasing pull strength, That even if speed becomes most of the uses.

For such that are less prototypes these powerful pulls could hook up to larger coils. Or meander as a hair to thread to eventually rope. Backtracking this is moving to more horse power.

Derive electric motor hints.

A turning t magnet or its’ oscillates back and forth.

Flip the magnetic field sections.

Work from the simple hit and miss like an old motor effect.

Cause, perhaps in vacuum, the effect for each dish out to find its former to be slow to it (and it's(and its previous slow)) and out going faster even tricked to stationary infinite to where you have your start at a infinite toward dimensions.

{ . . . this is pretty much separate here, but could be best to word in now . . . At the words ‘dimensions as a double to infinite, soon to be read below, insert at least mentally/casually the following; [ . . . As you work on infinite void space dimensions for more room it is important for you not to think of them overlapping and then in smaller versions—imaginable—one day strong against appearing adjacent. We have the power that if you throw enough power to anything, something is going to happen. If for dispel or horror you need a crutch, use 3 or 4 bars across a dented, hole or best used hovering toward the ‘end. 3 or 4 bars welded together by 2 across. Any working to causing multiple J Lukes is to be avoided, please. And careful with flukes. Finally, obvious with singularities, it is requested not to go with small in these large endeavors.] and {Power against power crux karate chops are aimed best with the c, general speaking, chop.) ( . . . but, yeah . . . we can sit inside a dimension—our own—and the radio waves will be very short range. Still, and spring cleaning lead paint with each not so shiny layer refracting out; domes (I'd prefer space suits, painted), ‘fire walls silent moving out like a separable hull, psychobabble to stray from crux, and finally . . . say, 3 but not more than 5 concentric spheres. Thank you for your patience in this though it is not really a part of the devise we are now going back to.) { . . . and repetitions and hype on the 3 or 4 bars. At hand, remembering a good ‘book for the pull to good scenario cross-referencing SOP words bent and prepared for bent at that even quick used up. Meanings in sentences changed—for the good—beyond theoretic and cap of belief encouraged to start with enough power thrown at the chop’. On dimensions as a double to infinite) (ignore but if you miss, back now is a good aiming stake-area) (ready) And, now, have the materials to at least send increasing speed in to the middle plate.

Inside of it is the apparatus axle.

Here it is worthwhile mention that only polarity and not movement of the axle is necessary for this effect. A note that, maybe bled, extra power can be inserted in a stationary axle.

Many people would build it to hovering and then stare at it, head at least at a slant, looking for inspiration.

Making genius on a brain teaser by using even to near or at a parity, Packard to its stop or whole potential or long term’ potential at parts durability and relation’ capability (thank you for your cooperation not your participation) Parts of sections in relation to each

other if not max out with those that are not dispelled, don't till a part of environment and then don't, in a single apparatus collates the potentials˜

parts in joy of puzzle solving perhaps to it being bored in a solid rock or even expensive ice by even such as a lathe. Such as parity is not even total necessary. As an expandable, the devise's work-out potential is developmental and a, like, component of the devise, not a dare for spastic competition.

Near total placed to not cause a detrimental spin falloff. Meet the family cave man rock station. If someone dispels this thing with its use of magnets I'm gonna have a hissy-fit. After wards you wouldn't even tell it and too great a loss . . . . And be careful what dispels you leave out too, perhaps announced, engineered, as need be . . . .
Many would or Says

Avoid sudden dispelling of the apparatus

Think toward a mindset of restart but without causing it such to be needed.

Use the innate re jerk of magnetism.

I'll use one by someone else. A thing is easy once done.

A form of flipping the magnetic field.

Use a timed, electric eye timed which can also be developed into improvements in spin, it's power bled converted and from that own coil.

As a field nears it's fade, a strong arranged field pulls

Fold the old field quickly at a ninety degree angle as an end to that bits pull, by mechanical (slide rule enacted . . . ) and the next strong field fields.

More horse power by increasing pull straight

Use deep focus.

Wait for other's improvements.

Remind each other not to use but compassionate completion and avoid any dispel.

Derive electric motor hints

A tuning t magnet or it oscillates back and forth.

Flip the magnetic field section.

Prepare for a simple presentation to the public avoiding dispel or ozone blimps.

Work from the simple hit and miss like an old motor effect Cause, perhaps in a vacuum, the effect for each dish out to find it's former to be slow to it (and it's previous slow.)—Straight Time, two most important words in History, and with t-travel bogus.

Build it to hovering and then stare at it, head at least at a slant, looking for inspiration.

The speeches I have now put into the forth coming Space Ship non-provisional. It is about also a Diplomatic shape, so it is the best place for my opinionated.

The speeches go, like, Regular Army Doctors, 15 minuets, God help us all . . . . Getting them from spies is hard because the doctor is the real axle for healed and back up to Constantinople enjoyment of any Wealth cow-patty, 2 bits, or (and we have those that do) real and real good machines that go bleep.

Staying with Diplomacy, the planet is so diplomatic that they but spies are ˜Capt. Kirk and need little to stop proceedings beyond pointing at an apple. MASA's side switch, rarely available First Brain on Mars getting thoughts with getting past spies or a moment in time where we find some one or thing that enables local but without any disaster or brainstorm allowed with good reason in here. The Army wins and protects doctors, joined at the hip even if your blood boils. War-oh faux paw and back to Diplomacy Biltmore wine and chicken; pay them back and the vets back. Mortgage though. Now, here about Figures;

### DETAILED DESCRIPTION

Generator Section 5,

Detailed description page of drawing of generator showing what Figures (listed Fig.) have as their explanation.

FIG. 1 Concentric out

FIG. 2 Polarity push out

FIG. 3 Hovering

FIG. 4 Axle pushes

FIG. 5 Base, top, and hull prevent explosions

FIG. 6 Coil on coil produces alternating current (AC)

FIG. 7 AC/DC converters, balanced or such as balanced best, provide such electromagnets power

FIG. 8 Stationary axle's coil as dish moves around it with it's coil, has effect of its own energy: polarity

FIG. 9 Top, bottom ad hull And axle, steady, have polarity by their coils being bled, although stationary

FIG. 10 Product energy coils are arranged not to impede apparatus' proper

FIG. 11 Hollow, solid thick, or thin disk can be used. The last especially enlarged, float still seen

FIG. 12 Different steel rods an be used, wrapped, or you can even use bar or refrigerator magnets

FIG. 13 Here, the deft medium is shown important, even if it is glue

FIG. 14 Bored at or near for flush, holes' enable Nearly Squares with Them having bolt and nut Indent

FIG. 15 Machined Plateau: cardboard/frig mags-flexi glass/covered wrap bolts-ceramic and advance E-mags

FIG. 16 Dream move by of counter rotating concentric hulls and interior flywheels for gyroscopic precession

FIG. 17 In freefall one on to is attainable stop and slowing to rev again as the next gets up its part of speed . . . .

FIG. 18 More sales for electricity in better transitions' for electric motors, perhaps flywheel based, makes $

FIG. 19 A housing bouncing betty into a plug, small version on a 30 watt's stem, hook to a rev up flywheel . . . .

FIG. 20 Portable generators not on fuel, massive arrays, light for going up to have great wind fall of power . . . .

FIG. 21 Cylinder Version
Many would, may or says . . .

Many people would prepare a simple presentation to the public to avoid dispel or ozone blimps . . . . So fine jeans and such, mean on this planet with walkums up to no good requires no psychology or affect our own mass laws. As an axiom, keep after the silent governmental—we have good govemrnment—boldier and those who for a laugh stack toys from foster hells and hunger cures—if delivered, more than enough as lottery money actually reaching—no limit—teachers, tops, who can better buy or with an amount for expense get school tools. Don't make waves out of your old dorm, provide students toward making more jobs in industry. Where the neon turns to would, keep the middle off those who can truly call Themselves normal, the red blooded average who are lucky to have a hiding place. We really mean it, no quiet small mass abuse.

Brushes are unnecessary and without them the mechanism is more beautiful, timeless, and capable.

Magnets inserted at or near flush in drilled maneuver holes.

Do not stack higher than weight will not allow a bit of distance between pushing magnets.

Two flexi glass doughnuts, distanced for their nut and bolt wound electromagnets bent or no is two plates acting as a single dish, perhaps with the O's edges having say . . . , a 3 or 4 inch wide sliver of the flexi glass glued to meeting and glued or melted together at their junction. Not limited to but a easy hollow single dish discription.

You can use a Bell Glass Jar vacuum or other if you wish.

As you are stacking dishes, use the best flush to hover by polarity. Your learning how to think of a complex machine!

You will want like what the Army knows is the only thing for them to do is Win. The way to do this is always the same; you come up with a new item for spin. This is the only thing you must do.

A quick minuet start-up to spin is recommended.

Many people would whittle a magnet ship in a bottle to like a carved jewel. Imaginable to you really, huh?!

Many people would angle and use some separation between magnets.

Many people would bend polarity push.

Many people would combine some or near or at all the different methods.

Many people at a drop would stop current and then another nearby to current area engaged if by battery on/off.

Cylinder versions can be heavier.

Product current to the limit of operation can, well, light lights. Remember the first man on the moon?

Bobby McGee is looking for that home. Back 9. White out without book burning ready? Wait till you see the next Non-provisional.

Pretty bird, Jump outta there, Big bird, gonna put it on you . . . (white out?)(white out if we miss to some kind of dispel?):

Counter rotation can facilitate infinites with as stationary in dimension no limit space is not a stop.

Though void, continuing and that a way of looking at infinite beyond 100% to, presently, just at a bit beyond total.

Not to step especially on your toes but this prep. if my other speeches go out; Saying no to people getting something delightful that causes no harm is wrong redouble if more than making them feel wrong about wanting to have a good thing . . . “No’ for the sake of saying no, . . . ‘You can’t have that’. That's police too wrong. Hey to Defiance!

The beavers got it to WWII, our 4 button animal height; Then we tore that engine down around a jug. I Tore apart sewing machines and repaired vacuums after that.

. . . their shy . . . when three girls laugh at you from around a corner, it means they like you, The difference causes a great deal of confusion. At least say ‘Hey Dar’. Your value means contact point maybe but, necessary in a flux, with meanness out there to artichokes. I'm sorry meanness exists but I'm one of the ones—thick she would call it and don't turn away—who doesn't understand meanness at all. I'm not an artichoke and times like these when my mind is made a blank I describe as “Jennifer said ‘its bad’” She really needed that one, obscure though it be to me now, bad. Back? Don't play scenarios. And, breaking free, always grant her her one finger rule; yes, Muscles, over there. And anything for the lady. Nothing makes her happier than no leader—the truth you might be running from is so small(three licks with a wet noodle) but its as big as the promise of the coming day(pine level) in Cave Men beating on each other. Base ball is an anticipation and she doesn't have to here men help each other. Now, the big one is that she watches as her demon rises by fight to devil, which while her favorite fantasy is give take on after resultant. So, you can help there as her demon and pine level up without and to you, thanks for your help to her, Angels.

Orion can cap cold war rust, get them out and only 2 or 3 weeks in and let them go even appearing doom itself with what happened in there especially with spies wanting the war. And I pulled my hitch short timers to one day and a wake-up. Orion is good for the job in its game plan, manifest destiny of an American type against the communist manifesto; which had to be beat as a cold war threat in the deterrent against them using even in talk stuff having an edge. They looked at the whole thing, we looked at frontier up, and a long term occupation as expansion from a black hole in a rough to spherical hold out stars there. Real save the universe stuff. That we were developing it to a fault, now, was a lot. Noticed was a thought of impediment to soviets, too. Capping separate, The Executive Branch is of in such Diplomacy by other means, stuck up only there like Jupiter the Genesis planet, but best left for generals to fight the wars. They know what their doing and back to lowest bidder but just need the Buicks . . . . There is, from behind the silent Governmental bolder, just one more . . . Once the spies are gone and a mirage of civilian Government is there and is us(and for me I mean US) there does exist the City . . . More than any port in a storm. The City is as good a civil service candidate as such as Oligarchy and Polysons. Don't get me started on the Justice Department and The Treasury Department. That bad. And women alone in DA and judgeships. And chicks in prison films, sure but no chicks in prison. ˜She just isn't capable of that such a crime. Anyway, Club(wood top, aluminum shoulders, no chain and unbroken armor mace)(no need for bark and balanced right size, and baseball mostly, Wiz you alone take wrestling beyond those who want to go pro any way and three rope pulls. The City is the luggage you don't want to loose even with covert bounce off showing. A Family like knights of Columbus, you just do it Still, in war, there is no octopus need at all and all functions can be done top to bottom with, but fog of war, no mysteries or hoping to get what you need even against more like yourself in remote up driving. Top to bottom, knowing the budget(and they are Paragons—VFW is within range—in always a way staying Paragons) Generals know the parameters and in a RLW know to win. Any thing else they should not be called upon for. They alone should/must be the ones who fight the Wars. As they would put it, Its My Job. They can tell you along the way that death is for the enemy and tell you what your censored letter to personnel desk ships you where. Not in war? Stay good at being ready and don't send in unless its tanks at least. [‘Nough covert looking a lot in Department of homeland security micro did it all organizations and without Department of Homeland Security Threat generals can keep at an appreciated cruise.][ . . . too much, 911? Then strike previous [ ] and it should work out better. Above all, avoid war with Diplomacy and such and bring the boys beck home. That is everything and to you and your family too.

Though he will say without the tech, he knows what to do down to mismanaged wealth, there is a civil service working and not ruling as Congress keeps popping up on Rome and in this can be Oligarchy as they are much more than any port in a storm. Elect farmers and builders with officer—preferably Army—background and believe it or not, not lawyers and such but, yes, Doctors. Next up is no changes at all in the civil service but a Alex in case and consultants son in poly.

It has been my experience with such devices that if you combine three forms of lucrative looking power producers and diligent bend their docking potential that you are headed toward a capable if not similar machine. Reverse order time on the last two solid paragraphs, please.—. {it was told to me that I was going to be . . . rich, so preventive maintenance. Don't do this to people. And never allow someone to wear this—Brainstorm—{ } White-out? Its just this one, why not cause I'd for real suggest do. In this stuff their a step away from first Brain on Mars. I don't want people hurt. So, I would say ‘when in doubt, white it out and, just before that send a copy to the NCANG.}

People are not playthings people matter is my commercial!

So good the first time, savor!

Congress is diplomacy in itself and a polite tickle—avoidable just like ro say, be my little baby for them too—, and must be the powerful in representative Democracy. If you want and can you can get my detailed game plan, but as large as democracy is, and its not got to go, there is room to make it work. Me? I still want direct democracy by Referendum. Pardon defending my right to say it if I went astray. Winding-upthe dusted homeplate in crispTechnicolorTop! Back inBlack! I'm Back inthe saddle again!
. . . AGAIN:

### GENERATOR, DETAILED DESCRIPTION

Magnets a nature's own perpetual motion devise.

Load stones are found on earth in nature.

Load stones rubbing a steel rod produces some magnetic polarity on the steel.

Polarity is north and south.

Every magnet has a north and south.

South on south repels.

North on north repels.

South on north attracts.

North on south attracts.

Same repel, opposites attract.

Coil on coil produces alternating current.

There are alternating current to direct current converters. These are plentiful.

Over times, as with the future there are better AC to DC converters develop.

A better converter can have a steady effect other than but as in a circle’ by also such as counter balanced.

Counterweight or other balance can be used. A drag slide rule for spin speed weighted even.

Wrapping, like, tightly around a steel rod with copper wire, back up, and then more wrapping in the same direction produces an electromagnet when you throw power to the copper ends.

You might use covered wire.

Electromagnets have a north and south and work similar to bar magnets.

Any DC battery can provide some DC current; also applicable as a replaceable potential part to the apparatus being described in this book section and step up and step down transformers in a near circular array can produce some power. The parts can be high voltage. But this slip-streamed own-motion hull is a bit alien and little stoic and not art deco for earth. Even if you use and replace heavy weight parts. Don't forget to dig the hole and build the dome.

There is no real need to think of the device's balance should be affected by the planetary poles.

Working toward give, prevents in latter industrial models the need for exacting low tolerance.

A DC battery can provide some electricity for a wrapped rod to be an electromagnet.

An electromagnet can be made,

An electromagnet has its own magnetism.

An electromagnet has it's own north and south, and it's own same attraction and opposites polarity push.

Catalysts; like, plastic glass, ceramics, and other readily available non-conductive materials can be used as a deaf medium. An amount of conductivity that may vary in different apparatus may help.

Flush is a word describing to near exact placement, smooth on/or top and bottom.

Start using regular magnets. Latter you can use electromagnets in much the same way.
Many would or may or says

Avoid sudden dispelling of the apparatus. Perhaps also show a way of the forces involved simply.

Think toward a mindset of restart but without causing it such to be needed. (The Army will be good at this; not relying only on such as hidden but also contingencies that are never their own cause even ready People in here where Alex can do so much good, though not overboard in money@like wooden nickels.) Use the innate re jerk nature of magnetism. As the field lessens in its force to ‘give and the next is jumped over to a strong pull. Occasional finds of re grab may be what you are looking for, like in recent industry.

I'll use one by someone else. A thing is easy once done.

A form of flipping the magnetic field. Magic and magnetic are similar words, eh?!,Power off next on Use a timed, electric eye timed[(which can also be developed into improvements, like in spin), it's power bled and converted], and/or automatic mechanical drop or that same but also off a slide rule instead of hitting a release even/or/and in magnetic field and which itself could also be other than easy as a distance between, next magnetism pull.

As a field nears it's fade, a strong arranged field pulls.

Fold the old field quickly at a ninety degree angle as an end to that bits pull, by mechanical or other (slide rule enacted . . . ) and the next strong field fields.

More horse power by increasing pull strength, That even if speed becomes most of the uses. For such that are less prototypes these powerful pulls could hook up to larger coils, or meander as a hair to thread to eventually rope. Backtracking this is moving toward more horsepower.

Use deep focus. Set further back . . . from flush and angled with even occasional . . . reverse polarity—turn around these magnets—giving a jump.

Wait for other's improvements.

Polarity arranged just inside and angled and turned or other trial and error experiments, here harmless, but, please with a guaranteed good resultant from scientific method. Straight to, Wiz.

Remind each other not to use but compassionate competition and avoid dispel.

Derive electric motor hints.

A tuning t magnet or it oscillates back and forth.

Flip the magnetic field sections.

Prepare for a simple presentation to the public avoiding dispel or ozone blimps.

paper process to first time max-out perfect can be done, but you don't have to worry about wasting paper . . . Amount of production can be extreme by being over engineered to even capturing the greatest amount of current even to the size difference in the dishes outer and inner coils.

That each dishes own coil as it moves in relation to the next interior coil out is much like one likewise on the interior axle with the first coil-first out—spinning while the axle(tubular shape) stationary but the coil on coil even with one not moving causing AC power, say for the axle's bled and converted polarity push or electric eye (perhaps prepared special such as for catch in increasing power at correct intervals, and spacing or even to ‘think in adjustments)—and/or—(prepared for’ in-flight adjustments in polarity push out, while stationary, but working to float out the first dishes inner edge flush magnets with it's own outer edge flush magnets much like the first floating doughnut pushing by polarity the next dish out. On the achieved by stationary or moving (as, though easier not to talk about that the axle can be made to move except here . . . ) base—not the axle ‘proper in the unmoving center cylinder of up in lines of push themselves incrementing to the top if more than one doughnut is used(noteworthy here is that a capping, stationary or moving polarity push down top may also aid in preventing the apparatus from explosive. The top, at baseline, receives its polarity push and electric eye energy in much the same way the axle does.) And the other concentric dish's floating flush magnets out and those aimed up for next dish up float(This is better, but yes you don't have to use each others section or whole polarity push.), perhaps with a beginning presentation of the machine that includes crutches beyond more than counter weights. And, of course, adding dishes out and up and out. (And, perhaps an outer perimeter ‘close-ring steadying and with it's power derived in much the same way as the axle. And up by under polarity push magnets on an under dish or a non-moving or moving polarity push up base, its coils perhaps stationary as the axle can be such as stationary and coil on coil is the only effect needed to derive energy. While the base and top and outside steady and axle can be made to move this is a simple way of understanding it. At each—or one—notch of polarity up for stacking dishes—or one—on the axle there is the at or near flush push away polarity for the first one level or (maybe changing distance) stacked plumb dishes, bleeding more power and weaker˜ for level distance. Perhaps incremented climbing(though useful, this is not to be confused with the difficult but productive development/maneuver of screw pattern or such around the axle for rising plate distance modifications.) from the first inside rising line around the axle, steady or variance lines, pushing for a stack of doughnut dishes and their floating magnets lip (maybe at or near flush) out to the next ones or stacks of doughnuts out beyond this second one maybe many more dishes out, (perhaps one day even cluttered synthesis out by the previous ring going to a point of building the next and then more to a point of flap producing further to perhaps a rip fan such as to deft dimensional power facilities and even as stationary infinite more disks produced just outside tinsel strength. Such would be a good test bay and use of a theoretical karate chop reflection or even refraction of perfect Hubble mirror surface tension for single layer, of cool to itself bounce back of all heat or other with strength unnecessary. This, more than a parasol, is a good market for its hard development) If desired, there is a second and other stacks of dishes out as the second and more as well as hovering from their bottom one by polarity. (Restrained synthesis of unending, though initially crude, coal could help pie %.) Many after placing one dish for an apparatus may be missing out on stacking dishes to a steadying top. Concentric floating by polarity doughnut dishes with each coil on coil powering by bled its such as electric eye or electromagnets and surplus power even by under and/or above coils to be bled surplus.

I know, but WWII Germany developed coal to petrol. Helps me, coal, gas.

Using coils in ways not in the way of the devise and floating, it is important to understand coil on coil concentric out is non-inhibiting the machine proper easy. Easy understood is in practice, again for ease, that the mechanisms workings are not hampered by coil on coil, though their product the energy. And that the coil on coil bend to the machines float, electric eyes, and AC/DC converters still places it in great areas and with great resultant. Torque not beyond polarity and spin mechanics and them, ‘coils, offset at places around and not impeding the devise it self's capabilities such as float capabilities allows coils shaped and juxtaposition almost anywhere. Maybe avoiding cattycornered. And working the same as, they, coil on coil, arranged concave around the dishes and in relation to themselves can at this one place be described much as fancier placement but still, coil on coil describes in other places well enough. Without time and effort management consultant perspiration as this section could produce, regular way of saying it is fine. Like saying too much is only an ignorable, repetition clarity can also prevent dispel. Amounts of coil thickness can be reduced or increased by such as a snaking of layers,’ wing warping or spreading including slinky, or even varying sizes for the machine's production to even be kept at or near optimum. This as a’ best description, but not all of potential. And the machine proper has bled power to itself and has its own coils for parts to have an ample amount of power. This important as you move in transferring priorities in best blend of machine proper in variances and its coils and the production’ coils. Easiest to understand in an envisioned prototype is that the coils are placed later at optimum and are in first practice anywhere else but what will at all impede the devises own float, AC/DC converter and electric eyes . . . Coil on coil is, except for here as a known, the best description. Keeping for growth is a part of this patent. Pushing beyond it not encouraged. If these two sentences do not help in this, consider them and this one struck. Feel free to use white out. And likewise on the next one or two. Even with all too quick resultant developed by this is too big and I thought of it and it must be mine puzzle workout people—you give me credit though it to you be only realizing magnets are natures own perpetual motion device, and pushing even in this for mine to be potentials under at least regular developmental expansion. Magnets full potential being realized.

Such known, regular or electromagnets hovering by polarity some dishes which themselves hold further doughnuts out by polarity and the parts such as dishes bleeding the energy they, the individual dishes' need for their function such as hovering with the whole using offset coil on coil for electricity production is still among the best present descriptions. Magnets in and around both interior and exterior curves of solid or hollow flexi-glass doughnuts float the next doughnuts out and all the doughnuts can have polarity push up by a circle of magnets floating up more doughnuts that can also push more out and the bled from their own coils power each doughnut needs can come from its own coils by coil on coil producing AC which by AC/DC converter, at least counterweighted, can also feed the doughnut and coil on coils to the exterior of the working machine produce a byproduct of electricity in one of the most efficient attempts ever to get full benefit of work effort by such as fire or heat directly into work effort.

Sames repel polarity push out, inner edge pushed away from previous outer edge, continuing, with under and over or through polarity hovering more above’ and coil on coil production. Magnets or Electromagnets, or mixed. You don't even need the drawing.

Separate if by white-out . . . Not without Priest, Wiz(nano), but a covered wrapped in the same direction no-miss scientific method could provide the believable norm for the creatures inside a lot of’ magnets, natures own perpetual motion device. ˜Funny how think about wrapped wire around steel seems to have only come after the invention of the battery, even with citrus everywhere back to the cave men. Final aiming is enjoyment, The Roaring 20's new what they had and, art deco, all you got to do is swing.

Magnets or electromagnets or mix, their parts own coil bled for the current they would need, sames repel polarity push out, inner edges pushed away from previous outer edge, continuing with under and over or through polarity hovering more ‘above and coil on coil energy production˜ The brief summary I am using.

When a Corp. builds its first . . . model . . . of the machine, Plastic-Glass—Flexi-Glass is recommended for the non-conductive frame.

Glue works on raising off the sheet below to the right height you need for

any base start and on next phases. Diagonal brace Flexi can all but handle a long screw or perforated for toward a final assembly cut and glue along non-right angles. At this point you could even use that glue in a mold. For an example, on the edge circular curve, light Flexi-Glass can be thick sliver cut and bent around say, two outside wheels(doughnuts) and glued to be the tread around the tire’; glued the strip's edges met and melted or glued together. Nuts and bolts with even not so smaller washers can help rigid and, with wound covered wire make great electromagnets using this extra area Even if with refrigerator magnets and cardboard, it is recommended to start out using regular magnets.

It Strained.

I started early in life on it and developed it over time.

The details, are mostly delete now and are lengthy and the reader may wish to skip to the next section,

### SUMMARY

This Generator is for more unlimited power.

Based on magnets as natures own perpetual motion devise the Generator is noticeable as the biosphere rotting as a continuous. The field of endeavor is energy. The subject machine uses hovering and push out by polarity and coil on coil to produce alternating current. The machines more complex parts have their own coil on coil current bled and going back into the machine part for polarity float, . . . maybe some AC to DC converted. Polarity pushes out other such parts, hovering. Coil on coil product current.

Production of surplus power. Proper quick description is magnets or electromagnets or mix, their parts own coil bled for the current they would need, sames repel polarity push out, inner edges pushed away from previous outer edge, continuing, with under and over or through polarity hovering more “above and coil on coil energy production. This is a machine that can go concentric out. The art was hindered by not using a natural continuous devise as easily now noticeable as natures own magnets. The subject will help in energy needs. In biosphere we're small and can receive unlimited dose of area of opportunity, elec.+

The film was made with Pat Penny of P&D Sales VCR camera and the tube version was mostly described there. P&D Sales can provide you with a Rainbow at (919)894-5551 or help you with repair of one. They helped a lot in letting me use it to make the movie. It may be something you can handle internally that the first 90's film of the VCR tape of the apparatus is more than sufficient, there.

The History Description is long but reasonably accurate and I would have docked some information, and did, but for trying for pertain at detailing while realizing such as most life history not here, now. As from my yout I was against spies, I worked toward an absolute platform that included handling the fuel crisis. I developed the engineering, carpentry/architect skills and work steady with minimalist tools(especially if I ever got to go up.) . . . I developed the ability to . . . retain . . . though without turning the walk-ums tassel retain across times by staying singularity of purpose on the machine I was developing for the then fuel crisis and potential others.

I wasn't tardy, The Generator was difficult and, as well as any start, the only start at all interesting started as a flywheel that cut in and out from electricity by at the first what I thought solar or step flywheels might work and is interesting only at as water heated from, around the flywheel, circular array of solar curves with a target tube of oil, heated, like in an old Popular Mechanics Magazine, which was my favorite feed your head—food—absorbing into basic I Am and dropping all but the non-max headroom of what I are, like a sponge going to be wrung. I had been lucky, which is the only real word for it, saying logged it in now, The Lucky Years. There was no Eureka or anything, just this has to be done on time and that almost worked a bit so if not then go to or then gone. I had it by UNC-CH but there I started toward real Poly Science and, taking a break for IOBC, a bouncing stop rapid fire cooled my WACO 1985 for a twenty year hunk to be taken out of my life. Got rid of the “I don't care, I want the big one . . . ’ wild things, though. Not real important in this, but helps to understand that the machine as well as my life has been frozen for twenty years with no change and its like I just woke-up. I recommend cryro, aimed by our numbers for the future to be successful that to the future, liquid nitrogen cracks to the brain are nothing and, with our goldfish(near alone) and not just the head(sorry, your back too!) we can stop waste of creation by ice, ribbon, now. Woooww . . . Forget you, were on this Now! This commercial is over. So is the P&D Sales one. This is kind of interesting; I read in a school text that two tops with a string between them move along it by gyroscopic precession if you bend the axle’ between them. This machine is a field day for such gyroscopic precession. Bled current for as if for itself in regular magnets or for itself in using electromagnets, disc parts hover and push others out with the part's own individual coil giving the part it's electricity and outside coils for surplus product, both coil on coil, resultant power. Magnets by their innate properties cause product at avoidance of problems associated with previous attempts. Polarity floating and pushing more like themselves out, parts bled their own coil power for polarity and surplus by coil on outside coil. Start at least using some bar magnets. A lot of the following are in the Detailed Description: Easy enough to understand for this, deflect bar magnets to push, . . . or use a oscillating T, a rotating T, or use a . . . !—The Mix; last about that is uninhibited in most things by then to at least a whatever to any thing you aimed at spied a brick. So the kid was eating and being fed though please be more careful in feeding your head though I know the lucky years don't want minutes on a landline to not be other than at least the type of earthling that doesn't notice the old’ are you an earthling solve the code. So as not controlled, here I must admit that I am computer illiterate and hate even keeping a dead phone to be an earthling. The last of the wasp gone with WWII worst mistake the Wall Street Journal and us 3(4) latched in this off the peripheral by the real How I Gave Up Hating and Learned . . . Rupen (Yeah, like so thick a war couldn't see it yittler) professor of the spy to a sickum of CIA and KGB just because we both read my Readak notes. If you know so much as that the Interpol Scotland Yard net is just the same spies, go tell them all. That does make sense at least to them. To you. Cheer's(and I mean it), you've solved the puzzle of the British are coming down to not just fire works but that they are actually bad for all the presentation of Diplomacy, as in the cartoon showing it in the Revolutionary war segments flicks. Carry the B. And in cryro, if the door opens, it closes again, no problem. Oh, and those people are crazy-stay away My little Rubic's cube has just poped up on me again.

Ship this and all Raider's boxes, best, to the NCANG, secret in Reserves.

It strained.

Proper quick description; Magnets or electromagnets, their parts own coil bled for the current they would need, sames repel polarity push up and out. Inner edges pushed away from previous next outer edge, continuing, with under and over or through polarity hovering more ‘above and coil on coil energy production. Polarity push and hover up and out with non-conductive medium and mix or bar magnets or electromagnets, such as can be made from a bolt and nut with covered wrap copper wire, to indicate sturdy, the circle out's own coils bled for such as polarity and exterior coils by coil on coil producing Energy (with it's own.), —automatic mechanical drop or that same but also off a slide rule instead of hitting a release even in magnetic field or such, which itself could also be other than easy as a balanced bump placed to not cause a detrimental spin falloff. Meet the family cave man rock station. Concentric. As a field nears its fade, a strong arranged field pulls. Strung diagonal from the previous E-Mag to make winds of the next, continuing, ends to bled power for that array.

Fold the old field quickly at a ninety degree angle as an end to that bits pull, by mechanical or other (slide rule enacted . . . ) and the next strong arranged field fields.

Use deep focus. Set further back . . . from flush and angled with even occasional . . . reverse polarity . . .

Turn around magnets . . . toward giving a jump.

Many may wait for other's improvements.

Remind each other not to use but compassionate competition and avoid any dispel.

Derive electric motor hints. Perhaps as near a field end, steady or jerky drop its and jerky or steady increase the next's power.

More horse power by increasing pull strength, That even if speed becomes most of the uses.

For such that are less prototypes these powerful pulls could hook up to larger coils. Or meander as a hair to thread to eventually rope. Backtracking this is moving to more horse power.

Derive electric motor hints.

A turning t magnet or its’ oscillates back and forth.

Flip the magnetic field sections.

Work from the simple hit and miss like an old motor effect.

Cause, perhaps in vacuum, the effect for each dish out to find its former to be slow to it (and it's(and its previous slow)) and out going faster even tricked to stationary infinite to where you have your start at a infinite toward dimensions.

{ . . . this is pretty much separate here, but could be best to word in now . . . At the words ‘dimensions as a double to infinite, soon to be read below, insert at least mentally/casually the following; [ . . . As you work on infinite void space dimensions for more room it is important for you not to think of them overlapping and then in smaller versions—imaginable—one day strong against appearing adjacent. We have the power that if you throw enough power to anything, something is going to happen. If for dispel or horror you need a crutch, use 3 or 4 bars across a dented, hole or best used hovering toward the ‘end. 3 or 4 bars welded together by 2 across. Any working to causing multiple J Lukes is to be avoided, please. And careful with flukes. Finally, obvious with singularities, it is requested not to go with small in these large endeavors.] and {Power against power crux karate chops are aimed best with the c, general speaking, chop.) { . . . but, yeah . . . we can sit inside a dimension—our own—and the radio waves will be very short range. Still, and spring cleaning lead paint with each not so shiny layer refracting out; domes (I'd prefer space suits, painted), ‘fire walls silent moving out like a separable hull, psychobabble to stray from crux, and finally . . . say, 3 but not more than 5 concentric spheres. Thank you for your patience in this though it is not really a part of the devise we are now going back to.) { . . . and repetitions and hype on the 3 or 4 bars. At hand, remembering a good ‘book for the pull to good scenario cross-referencing SOP words bent and prepared for bent at that even quick used up. Meanings in sentences changed—for the good—beyond theoretic and cap of belief encouraged to start with enough power thrown at the chop’.

On dimensions as a double to infinite)} {(ignore but if you miss, back now is a good aiming stake-area) (ready) And, now, have the materials to at least send increasing speed in to the middle plate.

Inside of it is the apparatus axle.

Here it is worthwhile mention that only polarity and not movement of the axle is necessary for this effect A note that, maybe bled, extra power can be inserted in a stationary axle.

Many people would build it to hovering and then stare at it, head at least at a slant, looking for inspiration.

Making genius on a brain teaser by using even to near or at a parity, Packard to its stop or whole potential or long term’ potential at parts durability and relation’ capability (thank you for your cooperation not your participation) Parts of sections in relation to each

other if not max out with those that are not dispelled, don't till a part of environment and then don't, in a single apparatus collates the potentials˜

parts in joy of puzzle solving perhaps to it being bored in a solid rock or even expensive ice by even such as a lathe. Such as parity is not even total necessary. As an expandable, the devise's work-out potential is developmental and a, like, component of the devise, not a dare for spastic competition. Near total placed to not cause a detrimental spin falloff. Meet the family cave man rock station. If someone dispels this thing with its use of magnets I'm gonna have a hissy-fit. After wards you wouldn't even tell it and too great a loss . . . . And be careful what dispels you leave out too, perhaps announced, engineered, as need be . . .
Many would or says

Avoid sudden dispelling of the apparatus

Think toward a mindset of restart but without causing it such to be needed.

Use the innate re jerk of magnetism.

I'll use one by someone else. A thing is easy once done.

A form of flipping the magnetic field.

Use a timed, electric eye timed which can also be developed into improvements in spin, it's power bled converted and from that own coil.

As a field nears it's fade, a strong arranged field pulls

Fold the old field quickly at a ninety degree angle as an end to that bits pull, by mechanical (slide rule enacted . . . ) and the next strong field fields.

More horse power by increasing pull straight.

Use deep focus.

Wait for other's improvements.

Remind each other not to use but compassionate completion and avoid any dispel.

Derive electric motor hints

A tuning t magnet or it oscillates back and forth.

Flip the magnetic field section.

Prepare for a simple presentation to the public avoiding dispel or ozone blimps.

Work from the simple hit and miss like an old motor effect.

Cause, perhaps in a vacuum, the effect for each dish out to find it's former to be slow to it (and it's previous slow.)—Straight Time, two most important words in History, and with t-travel bogus.

Build it to hovering and then stare at it, head at least at a slant, looking for inspiration.

The speeches I have now put into the forth coming Space Ship non-provisional. It is about also a Diplomatic shape, so it is the best place for my opinionated.

The speeches go, like, Regular Army Doctors, 15 minuets, God help us all . . . Getting them from spies is hard because the doctor is the real axle for healed and back up to Constantinople enjoyment of any Wealth cow-patty, 2 bits, or (and we have those that do) real and real good machines that go bleep. Staying with Diplomacy, the planet is so diplomatic that they but spies are ˜Capt. Kirk and need little to stop proceedings beyond pointing at an apple. MASA's side switch, rarely available First Brain on Mars getting thoughts with getting past spies or a moment in time where we find some one or thing that enables local but without any disaster or brainstorm allowed with good reason in here. The Army wins and protects doctors, joined at the hip even if your blood boils. War-oh faux paw and back to Diplomacy Biltmore wine and chicken; pay them back and the vets back. Mortgage though. Now, here about Figures;
Many would, may or says . . .

Many people would prepare a simple presentation to the public to avoid dispel or ozone blimps . . . . So fine jeans and such, mean on this planet with walkums up to no good requires no psychology or affect our own mass laws. As an axiom, keep after the silent governmental—we have good government—boldier and those who for a laugh stack toys from foster hells and hunger cures—if delivered, more than enough as lottery money actually reaching—no limit—teachers, tops, who can better buy or with an amount for expense get school tools. Don't make waves out of your old dorm, provide students toward making more jobs in industry. Where the neon turns to would, keep the middle off those who can truly call Themselves normal, the red blooded average who are lucky to have a hiding place. We really mean it, no quiet small mass abuse.

Brushes are unnecessary and without them the mechanism is more beautiful, timeless, and capable.

Magnets inserted at or near flush in drilled maneuver holes.

Do not stack higher than weight will not allow a bit of distance between pushing magnets.

Two flexi glass doughnuts, distanced for their nut and bolt wound electromagnets bent or no is two plates acting as a single dish, perhaps with the O's edges having say . . . , a 3 or 4 inch wide sliver of the flexi glass glued to meeting and glued or melted together at their junction. Not limited to but a easy hollow single dish discription.

You can use a Bell Glass Jar vacuum or other if you wish.

As you are stacking dishes, use the best flush to hover by polarity. Your learning how to think of a complex machine!

You will want like what the Army knows is the only thing for them to do is Win. The way to do this is always the same; you come up with a new item for spin. This is the only thing you must do.

A quick minuet start-up to spin is recommended.

Many people would whittle a magnet ship in a bottle to like a carved jewel Imaginable to you really, huh?!

Many people would angle and use some separation between magnets.

Many people would bend polarity push.

Many people would combine some or near or at all the different methods.

Many people at a drop would stop current and then another nearby to current area engaged if by battery on/off.

Cylinder versions can be heavier.

Product current to the limit of operation can, well, light lights. Remember the first man on the moon?Bobby McGee is looking for that home. Back 9. White out without book burning ready? Wait till you see the next Non-provisional.

Pretty bird, Jump outta there, Big bird, gonna put it on you . . . (white out?)(white out if we miss to some kind of dispel?):

Counter rotation can facilitate infinites with as stationary in dimension no limit space is not a stop.

Though void, continuing and that a way of looking at infinite beyond 100% to, presently, just at a bit beyond total.

Not to step especially on your toes but this prep. if my other speeches go out; Saying no to people getting something delightful that causes no harm is wrong redouble if more than making them feel wrong about wanting to have a good thing . . . ” No’ for the sake of saying no, . . . ‘You can’t have that’. That's police too wrong. Hey to Defiance!

The beavers got it to WWII, our 4 button animal height; Then we tore that engine down around a jug. I Tore apart sewing machines and repaired vacuums after that.

. . . their shy . . . when three girls laugh at you from around a corner, it means they like you. The difference causes a great deal of confusion. At least say ‘Hey Dar’. Your value means contact point maybe but, necessary in a flux, with meanness out there to artichokes. I'm sorry meanness exists but I'm one of the ones—thick she would call it and don't turn away—who doesn't understand meanness at all. I'm not an artichoke and times like these when my mind is made a blank I describe as “Jennifer said ‘its bad’” She really needed that one, obscure though it be to me now, bad. Back? Don't play scenarios. And, breaking free, always grant her her one finger rule; yes, Muscles, over there. And anything for the lady. Nothing makes her happier than no leader—the truth you might be running from is so small(three licks with a wet noodle) but its as big as the promise of the coming day(pine level) in Cave Men beating on each other. Base ball is an anticipation and she doesn't have to here men help each other. Now, the big one is that she watches as her demon rises by fight to devil, which while her favorite fantasy is give take on after resultant. So, you can help there as her demon and pine level up without and to you, thanks for your help to her, Angels.

Orion can cap cold war rust, get them out and only 2 or 3 weeks in and let them go even appearing doom itself with what happened in there especially with spies wanting the war. And I pulled my hitch short timers to one day and a wake-up. Orion is good for the job in its game plan, manifest destiny of an American type against the communist manifesto; which had to be beat as a cold war threat in the deterrent against them using even in talk stuff having an edge. They looked at the whole thing, we looked at frontier up, and a long term occupation as expansion from a black hole in a rough to spherical hold out stars there. Real save the universe stuff. That we were developing it to a fault, now, was a lot. Noticed was a thought of impediment to soviets, too. Capping separate, The Executive Branch is of in such Diplomacy by other means, stuck up only there like Jupiter the Genesis planet, but best left for generals to fight the wars. They know what their doing and back to lowest bidder but just need the Buicks . . . . There is, from behind the silent Governmental bolder, just one more . . . Once the spies are gone and a mirage of civilian Government is there and is us(and for me I mean US) there does exist the City . . . More than any port in a storm. The City is as good a civil service candidate as such as Oligarchy and Pulysons. Don't get me started on the Justice Department and The Treasury Department. That bad. And women alone in DA and judgeships. And chicks in prison films, sure but no chicks in prison. ˜She just isn't capable of that such a crime. Anyway, Club(wood top, aluminum shoulders, no chain and unbroken armor mace)(no need for bark and balanced right size, and baseball mostly, Wiz you alone take wrestling beyond those who want to go pro any way and three rope pulls. The City is the luggage you don't want to loose even with covert bounce off showing. A Family like knights of Columbus, you just do it. Still, in war, there is no octopus need at all and all functions can be done top to bottom with, but fog of war, no mysteries or hoping to get what you need even against more like yourself in remote up driving. Top to bottom, knowing the budget(and they are Paragons—VFW is within range—in always a way staying Paragons) Generals know the parameters and in a RLW know to win. Any thing else they should not be called upon for. They alone should/must be the ones who fight the Wars. As they would put it, Its My Job. They can tell you along the way that death is for the enemy and tell you what your censored letter to personnel desk ships you where. Not in war? Stay good at being ready and don't send in unless its tanks at least.[’Nough covert looking a lot in Department of homeland security micro did it all organizations and without Department of Homeland Security Threat generals can keep at an appreciated cruise.][ . . . too much, 911? Then strike previous [ ] and it should work out better. Above all.

1. Enclosed is the Claim as required. I invented the Generator. I claim the Generator. The un-wrote action of magnets is novel. Un obvious use of arrays provide such as hovering. I claim its potential is to the good of US industry. I worked on it over time. I claim the Generator.
